(19) United States
(12) Patent Application Publication
(10) Pub. No.: US 2017/0318412 A1
(43) Pub. Date: Nov. 2, 2017

(54) METHOD FOR TRANSMITTING DATA BETWEEN TWO SUBSCRIBERS

(71) Applicant: MAKAIO GMBH, Bad Homburg (DE)

(72) Inventor: Christoph SCHRAMM, Bad Homburg (DE)

(73) Assignee: MAKAIO GMBH, Bad Homburg (DE)

(21) Appl. No.: 15/526,409

(22) PCT Filed: Nov. 9, 2015
(86) PCT No.: PCT/EP2015/076020

§ 371 Date: May 12, 2017

(30) Foreign Application Priority Data
Nov. 13, 2014 (DE) 10 2014 223 211.2

(51) Int. Cl. H04W 4/00; H04W 76/02; H04W 4/18

(52) U.S. Cl. CPC H04W 4/008; H04W 4/18; H04W 76/023

(57) ABSTRACT

The invention relates to method for transmitting data between a first subscriber (22) and a second subscriber (24) using at least one conversion unit (10), wherein the first subscriber (22), the second subscriber (24) and the conversion unit (10) are configured in each case for wireless near-field data transmission with a first transmission method and a second transmission method. The second transmission method has a plurality of variants, wherein the first subscriber (22) and the second subscriber (24) are configured in each case to carry out only those variants which are incompatible with one another. An identifier is transmitted by the conversion unit (10) in a first step using the first transmission method. This identifier of the conversion unit (10) is received by the subscribers (22, 24) using the first transmission method. A direct wireless connection is furthermore set up between the subscriber (22) and the subscriber (24) using the first transmission method, wherein identifications of the subscribers (22, 24) and/or the identifier of the conversion unit (10) are exchanged.

Especially during events such as trade fairs, concerts or at busy locations such as airports, radio cells or, where relevant, an available infrastructure WLAN (Wireless Local Area Network) are frequently overloaded. One major challenge facing the engineer is to determine how data can nevertheless be exchanged between users?

This requires mobile devices or computers with at least one of the following transmission technologies:
Wi-Fi Direct (e.g. android)
P2P Networking (iOS “Multipeer Connectivity Framework”)
Bluetooth Low Energy,
CFNetwork,
Bluetooth.

An optional addition to this would be an Internet connection via conventional transmission paths, such as e.g. WiFi, GSM, UMTS, LTE.

Specific frameworks and technologies, which will be described briefly below, are already provided by device and software manufacturers:

a) Wi-Fi Direct

Industry standard which is contained e.g. in Windows Phone 8.1 and Android, but not in Apple iOS.

b) Multipeer Connectivity Framework

HiLevel Framework created by Apple, enabling ad-hoc device interconnection similar to Wi-Fi Direct. It can provide a connection via Bluetooth also, but is not compatible with Wi-Fi Direct.

c) CFNetwork

LowLevel Framework from Apple for TCP/IP connections. It provides connections in infrastructure networks, but also via Bluetooth.

d) Bluetooth Low Energy

Industry standard created, in particular, for heart rate monitors and similar devices which do not have a high energy consumption. It is supported by Windows Phone 8.1, Android and iOS. The maximum packet size is very small (device-dependent<120 bytes, often only around 20 bytes).

A common feature of all these boundary conditions is that they apply to only some of the conventionally available devices, and not absolutely to all devices. These technologies essentially set up “ad-hoc networks” without an infrastructure WLAN having to exist (e.g. through a WLAN Access Point).

Against this background, one object of the present invention is to propose a system by means of which it is possible to implement and switch data of “clients” (subscribers) on the same or on different platforms, and in fact in such a way that the data are transmitted as quickly as possible, subject to prevailing constraints.

A method is proposed for transmitting data between a first and a second subscriber using at least one conversion unit, wherein the first subscriber, the second subscriber and the conversion unit are configured in each case for wireless near-field data transmission using a first transmission method and a second transmission method. The maximum data transmission rate of the second transmission method is higher than that of the first transmission method, wherein the second transmission method has a plurality of variants and wherein the first subscriber and the second subscriber are configured in each case to carry out only those variants which are incompatible with one another.

In the proposed method, an identifier is transmitted by the conversion unit in a first step using the first transmission method. This identifier of the conversion unit is received in a subsequent step by the first and the second subscriber using the first transmission method. A direct wireless connection is furthermore set up between the first subscriber and the second subscriber using the first transmission method, wherein the identification of the subscribers and/or the identifier of the conversion unit are exchanged.

In the method, it is furthermore provided that the conversion unit is configured to carry out at least one variant of the second transmission method of each subscriber, and that a connection through the mediation of the conversion unit is set up between the first subscriber and the second subscriber, wherein the subscribers in each case set up a connection to the conversion unit using the second transmission method, and the conversion unit forwards data from the first subscriber to the second subscriber and conversely forwards data from the second subscriber to the first subscriber.

The proposed method enables the transmission of data between the first and the second subscriber at high speed, even if the two subscribers use transmission methods or variants thereof which are not compatible with one another. This is the case, for example, if the two subscribers in each case use different operating systems, i.e., for example, the first subscriber uses iOS as the operating system and the second subscriber uses Android as the operating system. A direct data transmission at a high data transmission rate between these two operating systems or platforms is not possible due to different implemented variants of the respective transmission methods. The problem is normally circumvented in that data that are to be exchanged are transmitted by one subscriber to a “cloud server” and are downloaded once more from the cloud server by the respective other subscriber. However, this solution to the problem requires an Internet connection, which is not always available. If an Internet connection is in principle available, the facilities provided for accessing the Internet are frequently overloaded, particularly during events, as already mentioned above.

Furthermore, many users additionally have misgivings concerning the protection of their data if said data are transmitted via the Internet. In the proposed method, first and second transmission methods are therefore used which are configured for a wireless near-field data transmission. Near field is understood to mean the field within which a direct communication between the first subscriber, the second subscriber and/or the conversion unit is possible using the first and the second transmission method without further components, in particular infrastructure components such as “WLAN Access Points” or mobile radio base stations, being used. The near field is therefore defined by the range of the respective transmission method and is normally less than 100 meters with a free line of sight and less than around 10 to 20 meters within buildings.

The transmission methods that are used are subdivided into first and second transmission methods, wherein the maximum data transmission rate of the second transmission method is higher than that of the first transmission method. Conversely, the first transmission method offers the advantage over the second transmission method that it requires less energy than the second data transmission method. The first transmission method is therefore used to establish the presence of the first and the second subscriber and also the conversion unit, and to transmit their identifiers or identifications. Due to the lower energy requirement of the first transmission method, reception is preferably carried out continuously using the first method so that transmitted identifiers can be received at all times in the conversion unit. Accordingly, it is preferably provided that the conversion unit emits its identifier periodically due to the comparatively low energy requirement, wherein the time interval is predefinable and is preferably in the range from around 10 ms to 10 seconds, in particular 10 ms to 5 seconds.

The reception of the identifier of the conversion unit by the subscribers can be used as a trigger to perform further actions. For example, a subscriber can signal to the user that a fast data transmission through the mediation of the conversion unit is available.

In a development of the method, it can be provided that the subscribers also emit their respective identification using the first transmission method, wherein the time interval may similarly be in the range from around 10 ms to 10 seconds. The subscribers and/or the conversion unit are similarly configured here to receive the transmitted identifications of the subscribers continuously using the first transmission method.

According to the proposed method, a direct wireless connection is set up between the subscribers initially using the first transmission method for the transmission from the first to the second subscriber, or vice versa. The connection is bidirectional. The identifications of the participating subscribers and/or the identifier of the conversion unit are exchanged via this direct wireless connection.

The maximum achievable data transmission rate of the first transmission method is normally so low that a transmission of the data using the first transmission method would take a disproportionately long time. Even in cases where the data could still be transmitted in an acceptable time using the first transmission method, it is nevertheless advantageous to use faster transmission methods, if available, so that the transmission can be completed more quickly. It is therefore provided in the method that the direct, wireless connection between the first and the second subscriber using the first transmission method is not used to transmit the data. Instead, the first subscriber and the second subscriber set up a connection to the conversion unit using a respectively supported variant of the second transmission method. This is possible since the conversion unit is configured in such a way that it can carry out at least one variant of the second transmission method of each subscriber. Conversely, a direct wireless connection using the second transmission method between the first and the second subscriber is not possible, since the variants of the second transmission method respectively supported by the first and the second subscriber are incompatible with one another.

After both subscribers have set up a connection in each case to the conversion unit using the second transmission method, the data can then be transmitted between the first and the second subscriber, wherein the conversion unit forwards data between the subscribers.

Information relating to the data to be exchanged are preferably transmitted via the direct wireless connection using the first transmission method. This information or metadata is selected, in particular, from information relating to the type of data to be transmitted, information relating to the data format, information relating to the required quality of the transmission, the quantity of data to be transmitted or a combination of at least two of these information elements. The data to be transmitted may, for example, be any files stored by one of the subscribers, for example contact data, in particular virtual calling cards, photos, applications, (apps) or parts of applications, text messages, web pages, links to web pages or links to files stored on the Internet.

The metadata may also comprise, in particular, information indicating which subscriber transmits the data and which subscriber receives the data during the transmission.

Moreover, the required quality and further transmission parameters can be specified via the exchanged metadata. For example, it can be specified whether the transmission takes place in binary form or as text. It can similarly be specified whether the successful transmission of the data is to be confirmed, or whether a confirmation of this type is not necessary.

For example, in the case of an end use or app for exchanging virtual calling cards between two persons, different requirements can be defined for the quality and the type of the transmission depending on the type of data to be exchanged. In one example, an end use on a Smartphone shows the image of a virtual calling card of person A. Person A then meets person B who owns a Smartphone with the same app which implements the same service. The Smartphones use different platforms or operating systems, so that a direct communication using the second transmission method is not possible. Only the first transmission method is available for a direct communication, but both Smartphones are interconnected as subscribers via a conversion unit using the proposed method. Person A then drags the virtual calling card on the display of his Smartphone with his finger from left to right. This calling card should then appear to person B in the image to the same extent that it has disappeared from the visible area of person A. If the calling card of person A has been completely “swiped” from the visible area and is completely visible to person B, person B obtains the contact data of person A.

As a result, the contact data and the position of a virtual calling card should then be transmitted. It is important for the contact data to be encrypted and complete. The transmission speed is of secondary importance here, so the channel is defined as follows:

Transmission type: Binary—due to the encryption

Transmission quality: Notifying—for reliable forwarding.

The calling card is transmitted from the Smartphone of person A to the Smartphone of person B through the mediation of the conversion unit. Since Notifying has been specified as the transmission quality, the Smartphone of person B acknowledges receipt.

Conversely, it is important for the position of the virtual calling cards to be transmitted as far as possible in real time, so the channel is defined as follows:

Transmission type: Text only (only the horizontal coordinate is transmitted)

Transmission quality: Broadcasting—for fast updating.

Since Broadcasting has been specified as the transmission quality, the receipt of the data by the Smartphone of person B is not acknowledged. Since the message is transmitted as text only, the entire overhead is eliminated. Information indicating how long the message is and whether it has been encrypted or signed is not transmitted. This information is quite simply not required, since text only channels cannot be encrypted or signed and are ended with a control character (EOM).

When the respective connection of the subscriber to the conversion unit is set up, the identifications of the subscribers are preferably also transmitted in order to effect the forwarding of data by the conversion unit, so that the corresponding subscriber is identifiable by the conversion unit. The identification of at least the subscriber intended to receive the data is accordingly also transmitted during the transmission of the data, wherein the conversion unit switches the connection. The conversion unit then forwards the data to the subscriber with this identification.

In the method according to the invention, the first transmission method which has a lower transmission speed but at the same time a lower energy requirement is used to locate conversion units and to exchange metadata with which the actual data to be transmitted are identified and can be more precisely designated. The actual data or useful data are then exchanged using a variant of the second transmission method, wherein the conversion unit switches between the two subscribers which could not otherwise communicate directly using the second transmission method.

It can be provided in the method that a subscriber, after receiving the identifier of the conversion unit, sets up a connection to the conversion unit using the first and/or the second transmission method, wherein the subscriber transmits its identification to the conversion unit.

As a result, the conversion unit is made aware of those subscribers which are located in the near field around the conversion unit, i.e. in the field in which a direct wireless data transmission by means of the first or the second transmission method is possible. As a result, the conversion unit can additionally alert the subscribers to services available in the near field by transmitting corresponding information via the connection to the subscribers.

“Bluetooth Low Energy” is preferably used as the first transmission method. This transmission method is characterized by its extremely low energy requirement, so that the subscribers and/or the conversion unit can transmit their identifier or their identification at periodic intervals and, conversely, can be configured continuously for the reception of corresponding identifiers and/or identifications. Bluetooth Low Energy is specified in the Bluetooth 4.0 standard, adopted on Dec. 17, 2009. Bluetooth Low Energy is specified and contained in successor standards also, particularly in the Bluetooth 4.1 and Bluetooth 4.2 versions also.

The use of Bluetooth Low Energy offers the advantage that Bluetooth Low Energy can be used as the only transmission method on a mobile device, particularly in the case of an iOS-based mobile device, by an app in the background, i.e. when the mobile device is blocked and/or the screen is switched off. As a result, it is possible that an app which is used to transmit data is “woken up” by the reception of the identifier of the conversion unit and can initiate further actions. After being woken up, the app can use the faster second transmission methods also, at least for a short time period.

The second transmission method can be carried out in one or more different variants which are incompatible with one another. The variants of the second transmission method are preferably selected from Wi-Fi Direct, Multipeer Connectivity Framework, CFNetwork and Bluetooth (not Low Energy).

Wi-Fi Direct and the Multipeer Connectivity Framework are both WLAN-based here, but differ in the implementation. One subscriber using, for example, Wi-Fi Direct cannot communicate directly with another subscriber using, for example, Multipeer Connectivity Framework.

Wi-Fi Direct is specified, for example, in the 802.11a, 802.11b, 802.11g and 802.11n standards belonging to the 802.11 protocol family, as valid on the application date, and is available, for example, if the subscriber uses Android or Windows Phone as the operating system. The Multipeer Connectivity Framework is a service provided in the Apple iOS operating system, which provides services for data transmission between iOS devices on the basis of WLAN networks or Bluetooth networks. The first subscriber is, for example, a mobile device based on the Android operating system, and the second subscriber is an iOS-based mobile device, so that a direct communication between the two subscribers is not possible.

Bluetooth (not Low Energy) defines different profiles for the wireless data exchange between two devices. Different profiles are implemented or made available for use here in each case by the first and the second subscriber, so that a direct connection between the two subscribers is not possible.

CFNetwork is a programming interface provided by Apple for data transmission and abstracts, inter alia, the access to data transmission methods such as WLAN or Bluetooth for the programmer. CFNetwork is not available on mobile devices which are not iOS-based, so that a direct communication, for example, between a first subscriber using iOS as the operating system and a second subscriber based on a different platform is not possible.

The second transmission methods are therefore preferably carried out using a wireless connection based on WLAN or Bluetooth, but the individual variants Wi-Fi Direct, Multipeer Connectivity Framework, CFNetwork or Bluetooth (not Low Energy) differ in the manner in which apps on different terminal devices can access them.

If a plurality of variants of the second transmission method are available for a connection between one of the subscribers and the conversion unit, it is preferable to select the currently fastest variant for the data transmission. The currently fastest variant may be defined, for example, by setting up a test connection using this variant and by measuring the data transmission rate that is actually available. All available variants can initially be tested and the best variant can then be selected. It is similarly preferable, if a connection is interrupted, for example, due to radio interference, to set up a connection using a different available variant of the second transmission method and to continue the data transmission at the point where it was previously interrupted.

If a specific transmission type and/or transmission quality has been specified via metadata, it is thus preferable to take account of this specification in selecting the variant of the second transmission method.

In the method, at least one of the subscribers is preferably implemented as a mobile device. A mobile device is, for example a Smartphone or a tablet (tablet computer), but other portable devices such as, for example, a laptop may also be involved.

It can furthermore be provided that one of the two subscribers is implemented as a server on which data are stored for retrieval. The server may, in particular, be a stationary computer which is configured accordingly to operate as a server. It is conceivable here, for example, for both a server and a conversion unit to be provided in the vicinity of a trade fair stand, wherein the conversion unit allows subscribers to transmit data at high speed from the server, independently from their supported variant of the second transmission method. It would similarly be conceivable for data, for example a virtual calling card, to be transmitted by the subscribers to the server.

It is furthermore preferably provided in the method that the data are transmitted between the subscribers in encrypted form. An end-to-end encryption can be provided in which the transmitted data are readable only by the subscriber defined as the recipient, or it can be provided that an encryption is performed at transport level, wherein the individual wireless connections between the subscribers and the conversion unit are encrypted. End-to-end encryption excludes the possibility of the conversion unit reading the transmitted data, as a result of which the trust of users can be increased. It can furthermore be provided that the subscribers participating in the transmission and/or the conversion unit are uniquely identifiable by means of cryptographic methods and their identity can be verified. Any method known to the person skilled in the art, such as, for example, RSA or AES, can be used to check the identity of the participants.

A further aspect of the invention relates to the provision of a conversion unit. The conversion unit is configured to carry out one of the methods described herein. Correspondingly, the features disclosed in relation to the methods apply accordingly to the conversion unit and, conversely, features disclosed in relation to the conversion unit apply accordingly to the methods.

The conversion unit comprises first and second transmission means, wherein the first transmission means are configured to carry out the first transmission method and the second transmission means are configured to carry out the second transmission method.

The conversion unit preferably comprises a first transmission unit which is configured to perform data transmissions according to Bluetooth Blue Energy.

The conversion unit furthermore preferably comprises two or more second transmission means which are configured in each case to carry out a different variant of the second transmission method. The second transmission means are preferably configured in each case to carry out at least one transmission method selected from Wi-Fi Direct, Multipeer Connectivity Framework, CFNetwork and Bluetooth (not Low Energy).

At least one transmission means is implemented as a mobile device, in particular as a Smartphone or tablet, wherein the mobile device is connected to the conversion unit. For this purpose, the mobile device is connected, for example, via a direct cable connection to the remaining components of the conversion unit. These components may be designed, for example, as a computer such as a PC or a server, and, together with the transmission means connected to the computer, may form the conversion unit. It may be provided, in particular, that at least one mobile device is disposed in the conversion unit as a transmission means for one or more supported variants of the second transmission method.

A plurality of mobile devices may also be provided as second transmission means, in each case implementing different variants. The conversion unit may, for example, have one Smartphone which is equipped with the Android operating system, and may have another Smartphone which is equipped with the iOS operating system. The transmission means based on an Android Smartphone communicates with subscribers similarly using Android as the operating system and, accordingly, the transmission means which are based on a Smartphone with iOS communicate with subscribers using iOS as the operating system. This enables the conversion unit to communicate with subscribers on different platforms or with different operating systems and to switch between these systems which are actually incompatible with one another.

It is furthermore preferable for at least one transmission unit to be implemented so that it is connected to the computer of the conversion unit or is integrated into said computer, such as, for example, a WLAN adapter or a Bluetooth adapter. Any mixed forms are conceivable here, so that the transmission units can be provided as any combinations of mobile devices and radio adapters. Variants in which all transmission units are implemented as a mobile device or all transmission units are designed as radio adapters can similarly be implemented.

In a further aspect of the invention, computer programs are provided to carry out the methods described herein. For this purpose, a computer program is proposed according to the invention which carries out the steps of one of the methods to be performed by a subscriber when the computer program is executed on a programmable computer device. The computer program may, for example, be an application which is executable, for example, on a Smartphone or tablet. The computer program may also be provided as a module or library which is used together with an application and is executed on a mobile device such as, for example, a Smartphone or tablet.

A computer program is similarly proposed, according to which the steps of one of the methods described herein to be performed by the conversion unit are carried out when the computer program is executed on a programmable computer device. The computer program may be executed, for example, on a computer system of the conversion unit.

The proposed programs may be stored on a machine-readable storage medium, on a permanent or rewritable storage medium or in allocation to a computer device or on a removable CD-ROM, DVD, BLU-Ray Disc or a USB stick. Additionally or alternatively, the described computer programs may be provided on a computer device such as, for example, a server for downloading, for example via a data network such as the Internet or a communication connection such as a telephone line or a wireless connection.

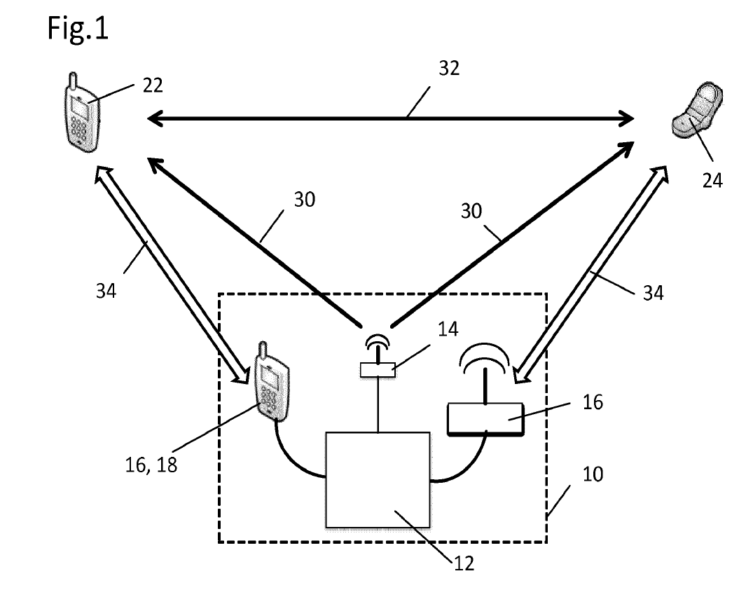

FIG. 1 shows an example embodiment of the method according to the invention. The figure shows the subject-matter of the invention in schematic form only.

FIG. 1 shows a conversion unit 10 comprising a computer 12, a first transmission means 14 and two second transmission means 16. The computer 12 is connected to the first transmission means 14 and the two second transmission means 16. The first transmission means 14 is configured here to carry out a first transmission method and the second transmission means 16 are configured in each case to carry out a variant of a second transmission method. The first transmission method is, for example, Bluetooth Low Energy and the second transmission methods are different variants of WLAN-based transmission methods. One variant is, for example, Wi-Fi Direct and the other variant is, for example, Multipeer Connectivity Framework.

In one embodiment, the computer 12 is a computer available under the name of “Mac Mini” (from Apple, USA) and already includes the first transmission means 14 as a component contained in the Mac Mini in order to communicate by means of Bluetooth Low Energy. The Mac Mini already includes a second transmission means 16 which is configured to communicate by means of the Multipeer Connectivity Framework. In order to be able to communicate by means of Wi-Fi Direct also, a mobile device 18 is connected to the computer 12 as the further second transmission means 16. The mobile device 18 is implemented, for example, as a Smartphone which uses Android as the operating system.

Two subscribers 22 and 24 can furthermore be seen in FIG. 1. Each of the two subscribers 22 and 24 is configured to communicate by means of the first transmission method, here Bluetooth Low Energy. Furthermore, in the example shown, the first subscriber 22 is also configured for communication with a second transmission method, i.e. here by means of Wi-Fi Direct. In the example shown, the second subscriber 24 is similarly configured to carry out a second transmission method, here the Multipeer Connectivity Framework. The first subscriber 22, for example an Android-based Smartphone, is therefore able to communicate by means of the second transmission method with the second subscriber 24, here an iOS-based Smartphone.

In the proposed method, it is provided that the conversion unit 10 transmits its identifier and said identifier is received by the two subscribers 22, 24. This is indicated in FIG. 1 with the arrows with reference number 30. The two subscribers 22 and 24 initially set up a direct wireless connection to one another for the data transmission, wherein the first transmission method, here Bluetooth Low Energy, is used. This connection is indicated in FIG. 1 with the reference number 32. The two subscribers 22 and 24 exchange their identifications via the direct wireless connection 32 via which said subscribers are uniquely identifiable and, if necessary, can transmit metadata relating to the data to be transmitted. In the next step, each of the two subscribers 22, 24 sets up a wireless connection to the conversion unit 10 using the respectively supported variant of the second transmission method. These connections are indicated in FIG. 1 in each case with an arrow with the reference number 34. Each of the two subscribers 22, 24 transmits its identification to the conversion unit 10. The two subscribers 22, 24 can then quickly transmit data from one subscriber to the respective other subscriber, wherein the data are first transmitted by means of the connections 34 set up using the second transmission means to the conversion unit 10 which forwards said data to the respective other subscriber 22, 24. On completion of the data transmission, the connections can be disconnected once more.

The subject-matter of the invention is also a system which has a server to which the clients can log in, indicating the platform on which and the format in which the data to be transmitted are dispatched by them and the format in which they expect the data which are to be received from other clients, so that said data can be further processed by the respective client, a conversion unit which converts the data formats of the clients into the data formats required by other clients and makes them available on demand, a unit for selecting the data transmission paths which are to be used for the converted data formats, wherein the availability of the respective data transmission path and the highest possible data transmission rate are priority selection criteria, in such a way that the data transmission path offering the highest data transmission rate with a given availability is used, and a connection unit which forwards the converted data onto the respectively selected data transmission paths.

Here, a client is a subscriber participating in the communication enabled by the system. The system comprising the conversion unit and the clients or subscribers is configured to carry out the described methods so that features described in relation to the method are disclosed for the system and, conversely, features described in relation to the system are disclosed for the method.

In practice, the clients may preferably be Smartphones working with different operating systems such as, for example, Android or iOS, which cannot normally communicate with one another due to the different platforms. However, other mobile devices such as, for example, tablets, are also conceivable. However, the system according to the invention is not limited hereto.

A server is understood in this context to mean a unit which is able to process the data of a client in the conversion unit so that a client on a different platform can further process the converted data. The server may be designed, for example in the trade fair domain, i.e. where a stationary counter is available for presentation purposes, as a stationary central unit such as a PC.

However, it may also be designed as a functional unit of one of the clients, i.e. the last client to dispatch data. All other present and logged in clients are then connected and retrieve the new message. As soon as they have retrieved the message, they themselves again become servers in order to forward the message.

The system according to the invention is advantageously configured so that, following the interruption of the data transmission on one data transmission path, the data transmission is seamlessly resumed on a different available data transmission path. As a result, data losses during the data transmission, but also any repeated data transmissions which otherwise become necessary, are avoided.

The system is preferably designed so that the login of the clients on the server is initiated by a software application stored in the clients following reception of initialization signals from Bluetooth transmitters in the peripheral role in the clients. Therefore, as soon as a client enters the near field of the Bluetooth transmitters, a “handshake” (mediation) takes place between the client and the server, wherein the method of communication between the two devices is negotiated. The approach of a client to a Bluetooth transmitter results in an outright “wake-up” of the client and the software stored in it.

Near field is understood here to mean the field around the Bluetooth transmitter within which the signal of the Bluetooth transmitter can be received by a client.

The data transmission paths used for the data transmission are preferably selected according to a strictly hierarchical system in which the data transmission rates known per se of the data transmission paths are used in ascending order for the data transmission. It is therefore ensured that the respectively fastest available data transmission path is used.

Alternatively, it can be provided in the system that the data transmission paths are selected using a real-time test of their respective data transmission rates. In this method, previously stored fixed values for the data transmission rate are not therefore used, but rather data transmission rates actually measured in real time and available.

The following data transmission paths are preferably used in the system: TCP/IP, Bluetooth Low Energy, Multipeer Connectivity Framework and/or the Internet. This list can be supplemented at any time with the emergence of new technologies.

The infrastructures which are intended to be supported are defined in a service. The system then links the corresponding connectors, which are understood here to mean de facto adapters, used by the system in order to set up the fastest available connection and to transmit and receive the message in the negotiated transmission standard.

If an application then wishes to search for remote stations with the same service, the system uses all available connectors (implemented by the service) in order to find these remote stations.

A connection begins with the exchange of the identifiers of both peers (remote stations). Each remote station, each terminal device can be uniquely identified via this peer identifier or identification. Every infrastructure can be connected to a remote station across all network topologies.

If the infrastructure of one connector is lost (e.g. because the application is placed in the background and e.g. the TCP/IP connections are automatically capped by the operating system), the system switches to the next fastest infrastructure. If a message has just been transmitted, the message is forwarded at the same place.

Bluetooth Low Energy is a special case here: since the transmission rates are very limited, the possibility exists e.g. of the exclusive exchange of the peer identifiers if no other ad-hoc infrastructure is available. A Web server can then be accessed with these peer identifiers and a “tunneled” connection can be set up between the two terminal devices: Peer A connects to the Web server and indicates that it requires a connection to Peer B. Peer B in turn indicates to the Web server that it would like to be connected to Peer A. The Web server then provides a buffer, receives messages from both parties and forwards them to the respective partner.

Finally, it can be provided that the data to be transmitted are encrypted in the system with AES or RSA. This obviously serves to increase data security.

An example of the use of the system according to the invention is given below in addition to the embodiments described in the claims:

An end use shows the image of a virtual calling card of person A on a Smartphone on which a special app is running. Person A then meets person B who owns a Smartphone with the same app which implements the same service. The two Smartphones are interconnected via the system. Person A now drags the virtual calling card on the display of his Smartphones with his finger from left to right. This calling card should then appear to person B in the image to the same extent that it has disappeared from the visible area of person A. If the calling card of person A has been completely “swiped” from the visible area and is completely visible to person B, person B obtains the contact data of person A.

As a result, the contact data and the position of a virtual calling card are intended to be transmitted. It is important for the contact data to be encrypted and complete. The transmission speed is of secondary importance here, so the channel is defined as follows:
Binary—due to the encryption
Notifying—for reliable forwarding.

Conversely, it is important for the position of the virtual calling cards to be transmitted to the extent possible in real time, so the channel is defined as follows:
Text only (only the horizontal coordinate is transmitted)
Broadcasting—for fast updating.

Since the message is transmitted as text only, the entire overhead is eliminated. Information indicating how long the message is and whether it has been encrypted or signed is not transmitted. This information is quite simply not required, since text-only channels cannot be encrypted or signed and are ended with a control character (EOM).

A further example of an application:

Company x wishes to access the contact data of a user using the system according to the invention. The app will receive the corresponding communication and indicate to the user “Company x wishes to access your contact data”. It must be possible to ensure that no one else can pass themselves off as “company x” in order to get hold of the user data. For this purpose, the public certificates of authorized remote stations (such as companies) are linked in the system. Company x receives the corresponding private certificate and then transmits the communication packets signed with the private certificate. The technical recipient can now verify the authenticity of the sender on the basis of the public certificate and can, for example, indicate the request for access to the contact data only in the case of a positive check.

An example of a procedure between a hotel guest and a hotelier may appear as follows:

The hotel guest installs the relevant app for the system.
The app loads stored public certificates from a server at the first start-up and at regular intervals
The hotel guest enters the hotel
A terminal device with the installed app of the hotelier regularly scans the environment and then discovers the terminal device of the hotel guest
The hotelier app generates a random AES password, encrypts it with a standard password stored statically in the app, signs it with a private certificate and transmits the encrypted and signed password to the guest app
The guest app validates the signing of the packet on the basis of the public certificate, decrypts the specific point-to-point password with the generic password and uses this password from then on for the encryption and decryption of all communication packets
Following successful validation, the message “Hotelier wishes to access your contact data” is indicated on the display.

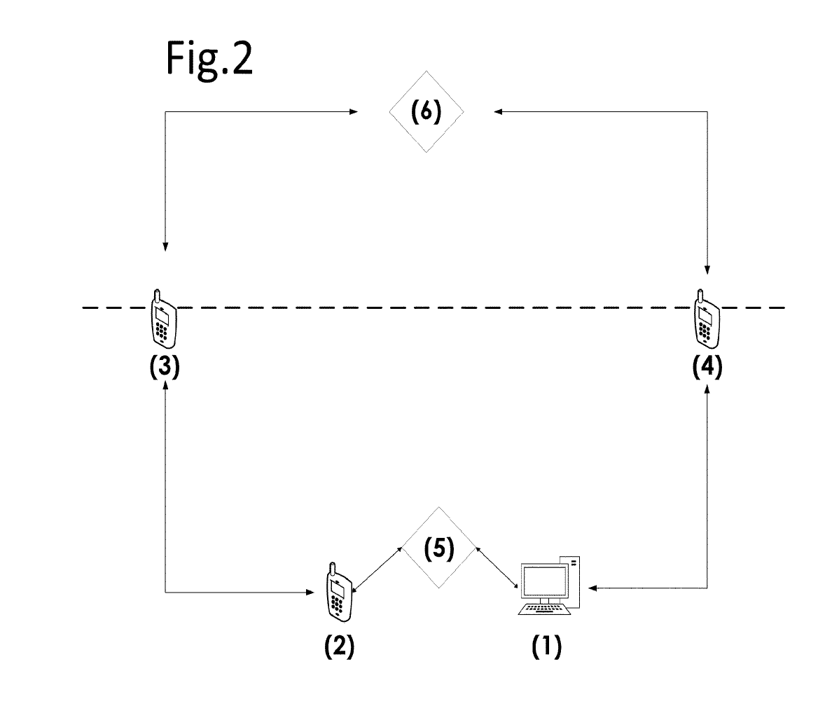

The system is described briefly in detail with reference to FIG. 2.

FIG. 2 shows the simplified structure of the system. An example of the structure of the system according to the invention is shown. It is in no way limited to this simplified representation.

The following components are shown: the server 1, the clients 2, 3 and 4, shown here as Smartphones, the conversion unit 5 and the Bluetooth transmitter 6. If a client 2, 3 or 4 enters the near field of the Bluetooth transmitter 6, it receives the latter's initialization signals so that the login of the client on the server 1 is initiated by the software application (app) stored on the client. A handshake then takes place between the client 2, 3 or 4 and the server 1, wherein the method of communication between the two devices is negotiated. The result of this handshake obviously depends on the platform on which the respective client is operated. In the case of a Smartphone, this will typically be the Android or iOS platform. However, the operation of the system according to the invention is not limited hereto. In other words, the approach of a client 2, 3 or 4 to the near field of the Bluetooth transmitter 6 to some extent causes a “wake-up” of the client and the software stored in it.

Once the communication between the client and the server has been negotiated, a communication can be started via a conversion unit 5 in which the data formats of the clients 2, 3 or 4 are converted into the data formats required by other clients logged in to the system and are made available on demand. As mentioned, a further client wishing to communicate with the first client must obviously be logged in for in this purpose. The server 1 therefore determines how and which data formats of a first client must be converted so that a further client can further process the data.

A connection unit (not shown) which forwards the converted data onto the data transmission paths is provided for the transmission of the data from one client to the next. The data transmission path used for the data transmission is preferably selected according to a strictly hierarchical system. The data transmission rates known per se of the individual data transmission paths (WiFi, GSM, UMTS, LTE, etc.) are used in ascending order for the data transmission, so that it is ensured that the respectively fastest available data transmission path is used.

The system has, in particular, the following features:

1. A system for converting and switching data of clients (2, 3, 4) on identical or different platforms, so that the data of one client can be further processed on the other clients, and for selecting the data transmission paths for this purpose in a near field, having:

a server (1) to which the clients (2, 3, 4) can log in, indicating the platform on which and the format in which the data to be transmitted are dispatched by them and the format in which they expect the data which are to be received from other clients so that said data can be further processed by the respective client,

a conversion unit (5) which converts the data formats of the clients (2, 3, 4) into the data formats required by other clients and makes them available on demand,

a unit for selecting the data transmission paths which are to be used for the converted data formats, wherein the availability of the respective data transmission path and the highest possible data transmission rate are priority selection criteria, in such a way that the data transmission path offering the highest data transmission rate with a given availability is used, and

a connection unit which forwards the converted data onto the respectively selected data transmission paths.

2. The system according to feature 1, in which the server (1) is designed as a stationary central unit.

3. The system according to feature 1, in which the server (1) is formed as a functional unit of a client which was the last client to dispatch data.

4. The system according to one of features 1 to 3, which is configured so that, following the interruption of the data transmission on one data transmission path, the data transmission is seamlessly resumed on a different available data transmission path without data loss.

5. The system according to one of features 1 to 4, in which the login of the clients (2, 3, 4) on the server (1) is initiated by a software application stored in the clients following reception of initialization signals from Bluetooth transmitters (6) in the peripheral role in the clients (2, 3, 4).

6. The system according to one of features 1 to 5, in which the data transmission paths are selected on the basis of a strictly hierarchical system in which their known data transmission rates are used in ascending order for the data transmission.

7. The system according to one of features 1 to 6, in which the data transmission paths are selected using a real-time test of their respective data transmission rates.

8. The system according to one of features 1 to 7, in which the following data transmission paths are used: TCP/IP, Bluetooth Low Energy, Multipeer Connectivity Framework and/or the Internet.

9. The system according to one of features 1 to 8, in which the data to be transmitted are encrypted with AES or RSA.

In connection with the described system, the method according to the invention can also be described with the following features:

10. A method for converting and switching data of clients (2, 3, 4) on identical or different platforms, so that the data of one client can be further processed on the other clients, and for selecting the data transmission paths for this purpose in a near field, comprising:

login of the clients (2, 3, 4) on a server (1), indicating the platform on which and the format in which the data to be transmitted are dispatched by them and the format in which they expect the data which are to be received from other clients so that said data can be further processed by the respective client,

conversion of the data formats of the clients (2, 3, 4) into the data formats required by other clients and making said data formats available on demand,

selection of the data transmission paths which are to be used for the converted data formats in the near field, wherein the availability of the respective data transmission path and the highest possible data transmission rate are priority selection criteria, in such a way that the data transmission path offering the highest data transmission rate with a given availability is used, and

introduction of the converted data onto the respectively selected data transmission paths.

11. The method according to feature 10, in which the server (1) is designed as a stationary central unit.

12. The method according to feature 10, in which the server (1) is formed as a functional unit of a client which was the last client to dispatch data.

13. The method according to one of features 10 to 12, furthermore comprising: the seamless resumption of the data transmission following interruption of the data transmission on one data transmission path on another available data transmission path without data loss.

14. The method according to one of features 10 to 13, in which the login of the clients on the server (1) is initiated by a software application stored in the clients following reception of initialization signals from Bluetooth transmitters (6) in the peripheral role in the clients (2, 3, 4).

15. The method according to one of features 10 to 14, in which the data transmission paths are selected on the basis of a strictly hierarchical system in which their known data transmission rates are used in ascending order for the data transmission.

16. The method according to one of features 10 to 15, in which the data transmission paths are selected using a real-time test of their respective data transmission rates.

17. The method according to one of features 10 to 16, in which the following data transmission paths are used: TCP/IP, Bluetooth Low Energy, Multipeer Connectivity Framework and/or the Internet.

18. The method according to one of features 10 to 17, in which the data to be transmitted are encrypted with AES or RSA.

1-16. (canceled)

17. A method for transmitting data between a first subscriber and a second subscriber using at least one conversion unit,
wherein the first subscriber, the second subscriber and the conversion unit are in each case configured for wireless data transmission in the near field with a first transmission method and a second transmission method,
wherein the maximum data transmission rate of the second transmission method is higher than that of the first transmission method,
wherein the second transmission method has a plurality of variants and wherein the first subscriber and the second subscriber are configured in each case to carry out only those variants which are incompatible with one another,
comprising the steps of:
a) periodic transmission of an identifier by the conversion unit and periodic transmission of an identification by the first subscriber and the second subscriber using the first transmission method,
b) reception of the identifier of the conversion unit by the first subscriber and the second subscriber using the first transmission method, wherein the subscribers and the conversion unit similarly receive the transmitted identifications of the subscribers,
c) setting up a direct wireless connection between the first subscriber and the second subscriber using the first transmission method, wherein the identifications of the subscribers and optionally the identifier of the conversion unit are exchanged.
characterized in that the conversion unit is configured to carry out at least one variant of each subscriber, and in that the method furthermore comprises:
d) setting up a connection switched by the conversion unit between the first subscriber and the second subscriber, wherein the subscribers in each case set up a connection to the conversion unit using the second transmission method and the conversion unit forwards data from the first subscriber to the second subscriber and, conversely, forwards data from the second subscriber to the first subscriber.

18. The method as claimed in claim 17, characterized in that metadata are exchanged via the direct wireless connection between the two subscribers, wherein the metadata are selected from information relating to the type of data to be transmitted, information relating to the data format, information relating to the required quality of the transmission, the quantity of data to be transmitted or a combination of at least two of these information elements.

19. The method as claimed in claim 17, characterized in that a subscriber, after receiving the identifier of the conversion unit, sets up a connection to the conversion unit using the first and/or the second transmission method, wherein the subscriber transmits its identification to the conversion unit.

20. The method as claimed in claim 17, characterized in that, for the forwarding of the data by the conversion unit according to step d), the subscribers transmit their respective identification to the conversion unit, wherein the conversion unit identifies the subscribers via their identification in the forwarding of the data.

21. The method as claimed in claim 17, characterized in that the first transmission method is Bluetooth Low Energy.

22. The method as claimed in claim 17, characterized in that the variants of the second transmission method are selected from Wi-Fi Direct, Multipeer Connectivity Framework, CFNetwork or Bluetooth (not Low Energy).

23. The method as claimed in claim 17, characterized in that, if a plurality of variants of the second transmission method are available for a connection between the conversion unit and a subscriber, the currently fastest available variant is selected.

24. The method as claimed in claim 17, characterized in that at least one subscriber is implemented as a mobile device, in particular as a Smartphone or as a tablet.

25. The method as claimed in claim 17, characterized in that one of the two subscribers is implemented as a server on which data are stored for retrieval.

26. A conversion unit characterized in that the conversion unit comprises first transmission means and second transmission means and is configured for use in the method as claimed in claim 17.

27. The conversion unit as claimed in claim 26, characterized in that the conversion unit comprises two or more transmission units which are configured in each case to use a different variant of the second transmission method.

28. The conversion unit as claimed in claim 26, characterized in that the conversion unit comprises a first transmission unit which is configured to carry out the Bluetooth Low Energy transmission method.

29. The conversion unit as claimed in claim 26, characterized in that the second transmission units are configured in each case to carry out variants of the second transmission method selected from Wi-Fi Direct, Multipeer Connectivity Framework, CFNetwork or Bluetooth (not Low Energy).

30. The conversion unit as claimed in claim 26, characterized in that at least one transmission unit is implemented as a mobile device, in particular as a Smartphone or tablet, wherein the mobile device is connected to the conversion unit.

31. A computer program which carries out the steps of the method as claimed in claim 17 which are to be carried out by a subscriber when said computer program runs on a computer.

32. The computer program which carries out the steps of the method as claimed in claim 17 which are to be carried out by the conversion unit, when said computer program runs on a computer.
